(19) United States
(12) Patent Application Publication
(10) Pub. No.: US 2020/0358312 A1
(43) Pub. Date: Nov. 12, 2020

(54) MICROGRID SERVICE ENTRANCE

(71) Applicant: MECL Holdings, LLC, Dallas, TX (US)

(72) Inventors: Mark Fisher, Dallas, TX (US); Adam Butt, Dallas, TX (US)

(21) Appl. No.: 16/409,410

(22) Filed: May 10, 2019

(51) Int. Cl. H02J 13/00; H02J 3/38; H02H 7/28; H02H 1/00; G05B 19/042

(52) U.S. Cl. CPC H02J 13/0017; H02J 3/381; H02H 7/28; G05B 2219/2639; G05B 19/042; H02J 2003/388; H02H 1/0061

(57) ABSTRACT

The disclosure provides a microgrid service entrance (MSE) and employing an MSE for controlling a microgrid. In one embodiment, the MSE includes: (1) an enclosure, (2) protective relays having bi-directional protection, (3) a communications module communicatively coupled to the protective relays, and (4) a power bus coupled to the protective relays and including a primary disconnect, wherein the protective relays, the communications module, and the power bus are located within the enclosure.

### TECHNICAL FIELD

This application is directed, in general, to electrical power and, more specifically, to connecting combinations of distributed energy resources (non-utility electrical sources) and electrical loads to electrical power grids of utilities.

### BACKGROUND

Electric utilities distribute electricity through electrical grids that are often referred to as wide area utility distribution systems. The wide area utility distribution systems form a macrogrid that delivers generated electricity to connected customers. As another option to traditional electricity service from utilities, microgrids are becoming popular for some customers. A microgrid is typically a small grid operating as an island to deliver power to a dedicated consumer or to a limited number of consumers, but can optionally have the capability of being connected in parallel with a macrogrid. The localized group of electricity sources and loads of a microgrid can function autonomously or operate in parallel with a macrogrid as the utility distribution system or economic conditions dictate. In this way, a microgrid can effectively integrate electrical service from the local utility with various Distributed Electrical Resources (DERs) and can supply utility, emergency, stand-by, or back-up power to either the microgrid or macrogrid by changing between island and parallel operation. Examples of DERs are wind, rooftop solar, energy storage, and generators that use clean burning natural gas or Tier IV diesel generators.

Microgrids have created an environment that allows facility owners to fully support their facilities regardless of the operational condition of the local utility. Protection and control of microgrids is necessary to ensure the safety of both customer and utility personnel and the proper operation of the microgrid for the electrical resiliency and economic benefit of its owner.

### SUMMARY

In one aspect the disclosure provides a microgrid service entrance (MSE). In one embodiment, the MSE includes: (1) an enclosure, (2) protective relays having bi-directional protection, (3) a communications module communicatively coupled to the protective relays, and (4) a power bus coupled to the protective relays and including a primary disconnect, wherein the protective relays, the communications module, and the power bus are located within the enclosure.

In another aspect, the disclosure provides another embodiment of an MSE that includes: (1) an enclosure, (2) protective relays configured to operate the MSE in at least three operating modes and provide redundant relay protection, (3) a communications module communicatively coupled to the protective relays and configured to send at least one instruction to the protective relays to enable operating the MSE in one of the at least three different operating modes based on a received command, and (4) a power bus coupled to the protective relays and including a primary disconnect coupled in series to an auxiliary disconnect, wherein the protective relays operate the primary disconnect in response to the at least one instruction, and the protective relays, the communications module, and the power bus are located within the enclosure.

In yet another aspect, a method of changing operating modes for a microgrid is disclosed. In one embodiment, the method includes: (1) receiving, at an MSE for a microgrid in a first operating mode, a command to place the microgrid in a second operating mode, (2) sending instructions, based on the command, to operate components of the MSE to place the microgrid in the second operating mode, and (3) indicating, by the MSE, that the microgrid is operating in the second operating mode.

### BRIEF DESCRIPTION

Reference is now made to the following descriptions taken in conjunction with the accompanying drawings, in which:

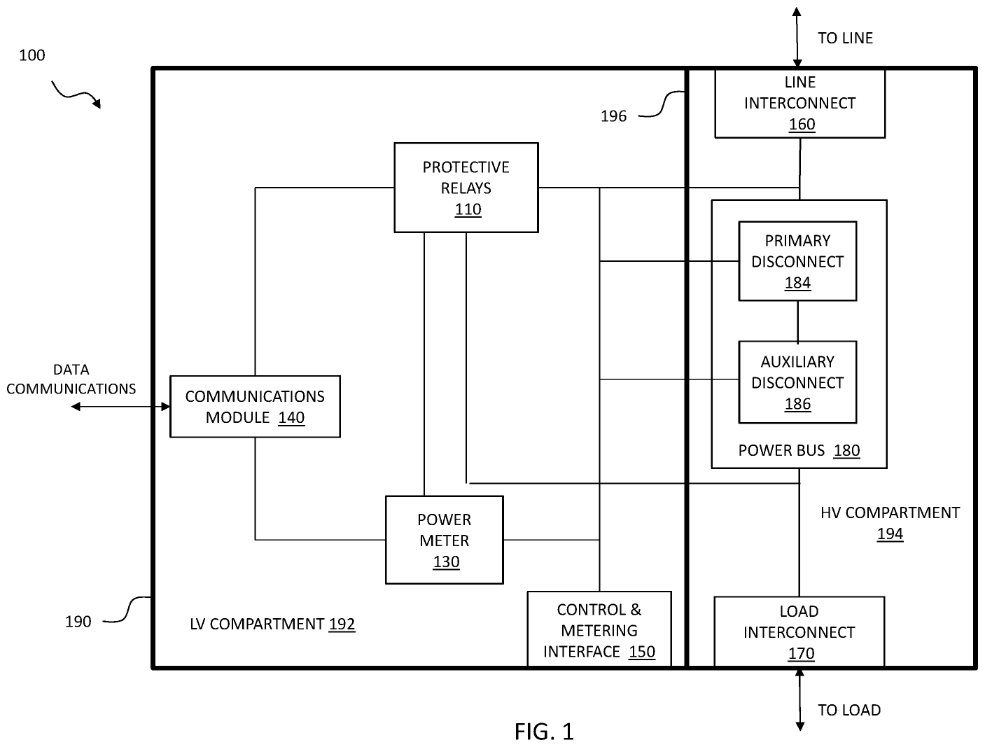

FIG. 1 illustrates a block diagram of an example of a microgrid service entrance (MSE) constructed according to the principles of the disclosure;

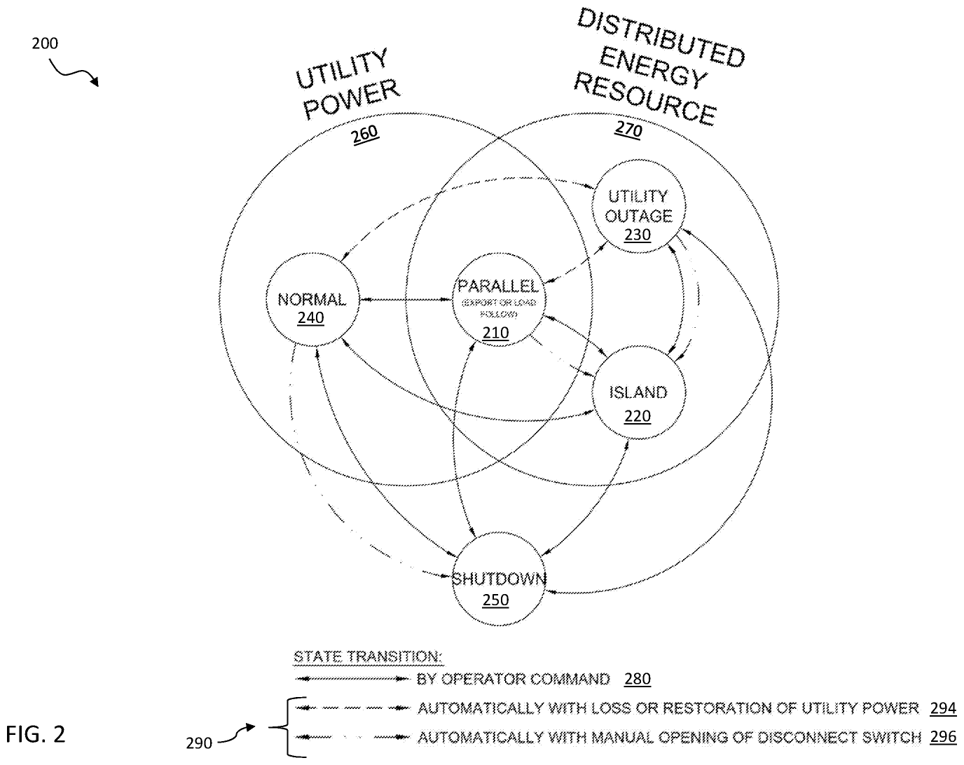

FIG. 2 illustrates a state diagram of the operating modes and transitions between the operating modes of an example MSE constructed according to the principles of the disclosure;

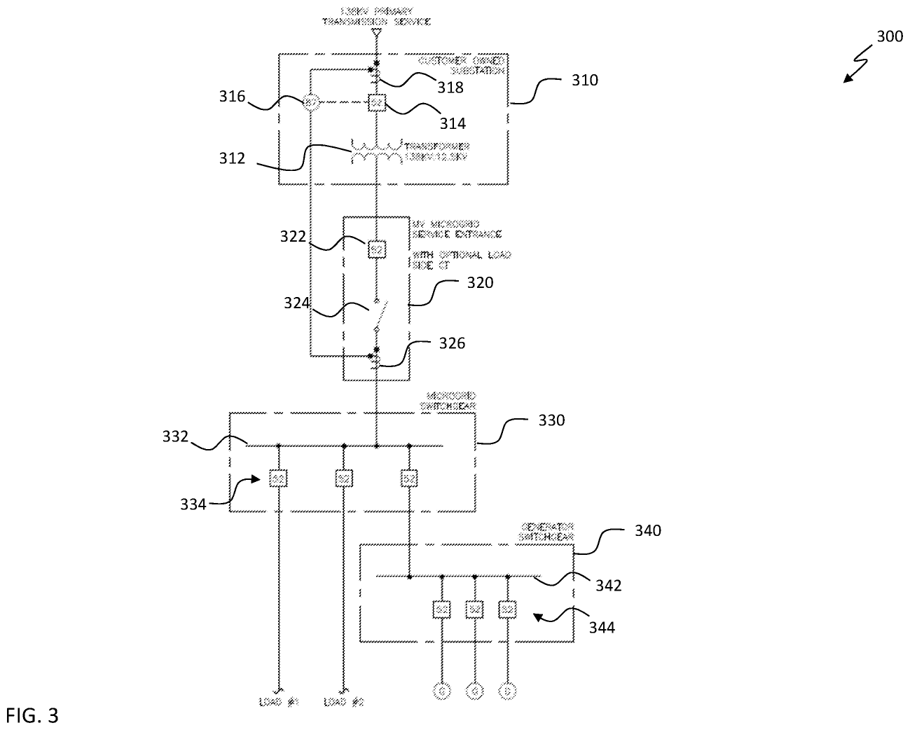

FIG. 3 illustrates a one-line diagram of an example microgrid system employing an MSE constructed according to the principles of the disclosure;

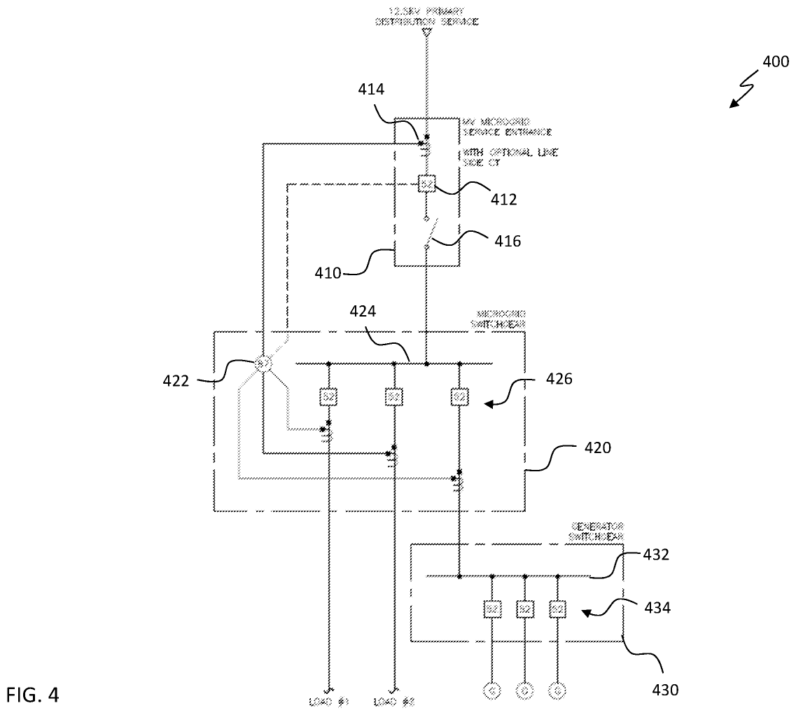

FIG. 4 illustrates a one-line diagram of an example microgrid system employing an MSE constructed according to the principles of the disclosure;

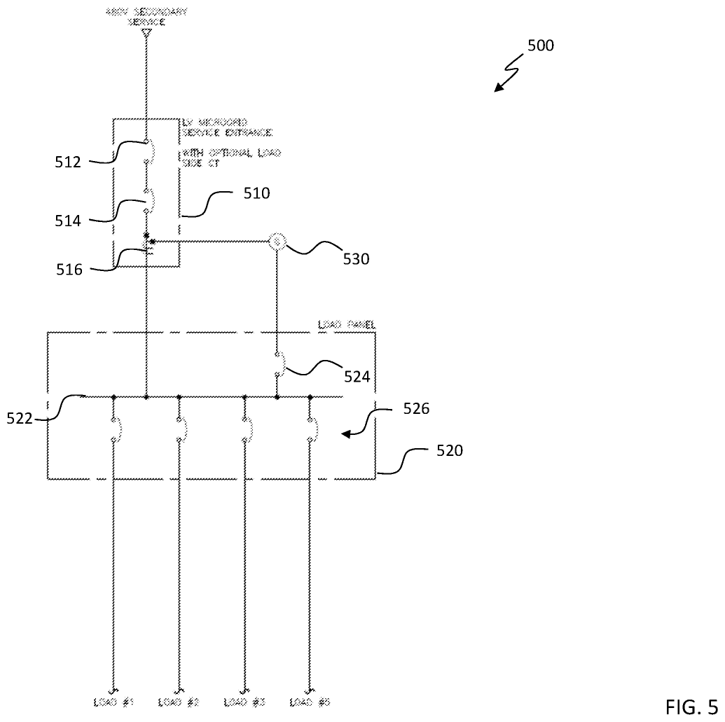

FIG. 5 illustrates a one-line diagram of an example microgrid system employing an MSE constructed according to the principles of the disclosure;

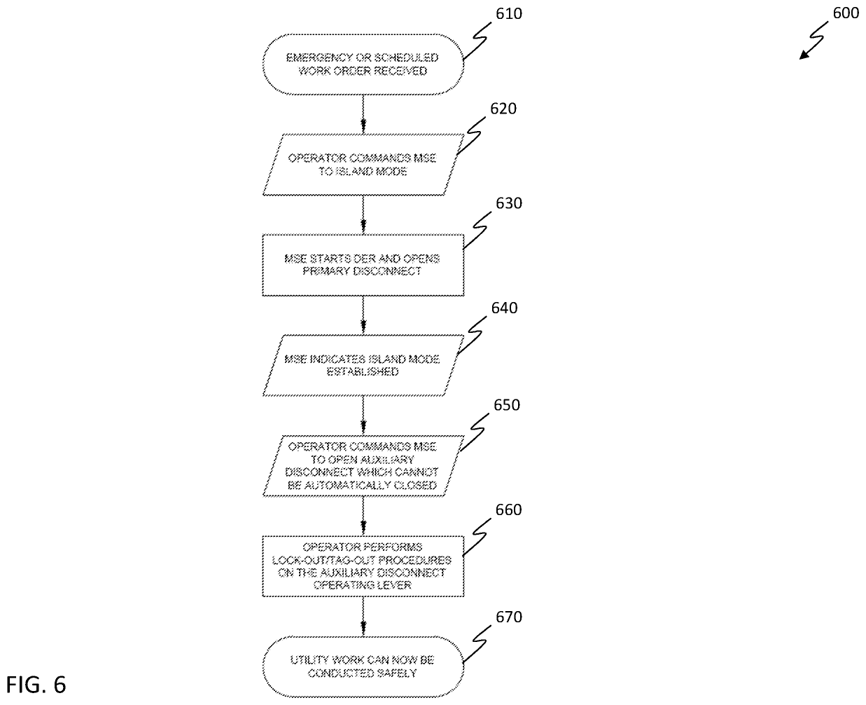

FIG. 6 illustrates a flow diagram of an example of a method of employing an MSE to place a microgrid in an island mode to allow utility work to be safely conducted; and

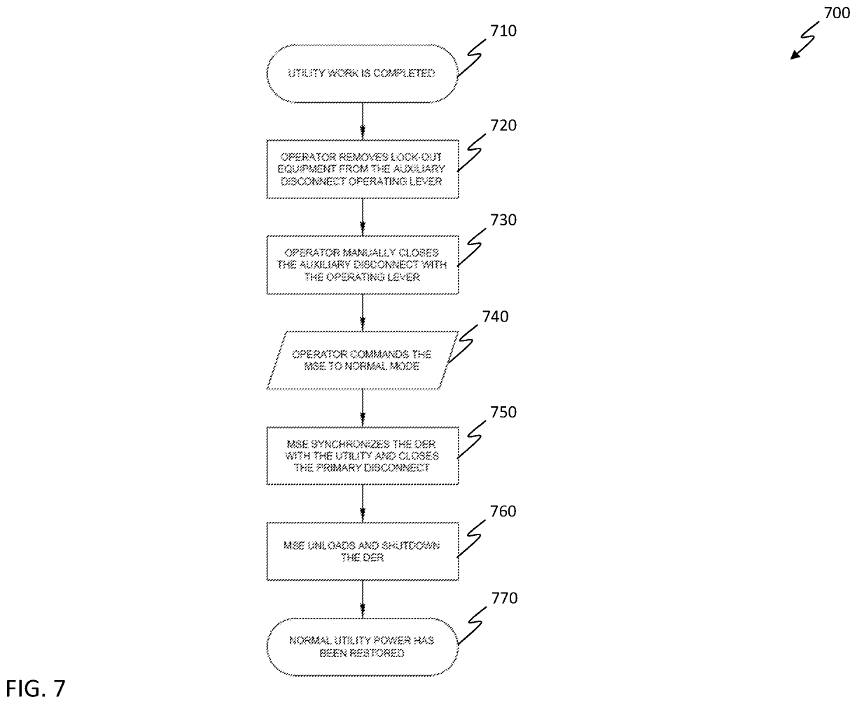

FIG. 7 illustrates a flow diagram of an example of a method of employing an MSE to place a microgrid in a normal mode.

### DETAILED DESCRIPTION

Utilities have created utility specific and non-aligned interconnection requirements for connecting microgrids to their electrical grids. The individual interconnection requirements have resulted in a broad range of segregated rules and regulations which have caused confusion to the marketplace. Industry standards for various countries have been introduced and are being developed to provide aligned interconnection requirements for microgrids. For example, Institute of Electrical and Electronics Engineers (IEEE) Standard 1547—Standard for Interconnecting Distributed Resources with Electric Power Systems was introduced to provide a single unified standard to increase the integration of microgrids into the utility systems. Many utilities, however, have kept their individual interconnection requirements in place of or in addition to the industry standards, such as IEEE Standard 1547.

For example, even though noted in IEEE 1547, a utility service provider may have their own requirements for a transfer trip scheme that has to be installed between the distribution substation of the utility's electrical grid and the microgrid to protect utility employees working upstream of the microgrid during an outage. The transfer trip would typically be initiated by the utility in the event there is a utility outage while the microgrid is exporting power and the microgrid does not automatically isolate itself from the distribution system and change to island operation. Communication for the transfer trip scheme is typically via a dedicated fiber optic link from the distribution substation to the microgrid. The cost for installing a fiber optic cable and related equipment in the substation to establish the link can greatly increase the cost of installing a microgrid and can greatly vary due to the distance between the substation and customer and the different requirements from utility service providers.

Thus, the difficulty of designing a compliant connection for a microgrid to the electrical grid of a utility and having the connection certified for operation is approved on a project by project basis; which can be both time consuming and costly. Accordingly, the disclosure provides a microgrid service entrance (MSE) that provides a universal solution for connecting microgrids to macrogrids. The MSE is engineered to meet the requirements of industry standards, such as IEEE 1547, and will streamline the interconnection process for microgrid projects. The MSE can provide engineers with a drop-in solution which satisfies multiple project and utility requirements and minimizes design and construction expenses. The MSE's redundant protective relays and specific upstream directional protection features can even allow microgrid owners to avoid the costs of installing a fiberoptic based transfer trip system or allow them to install a much less expensive cellular trip scheme.

The disclosed MSE provides a single solution for microgrid interconnection requirements that provides the benefits of operating a microgrid facility in multiple modes including supplying a load with power from only the utility provider, supplying the load with power from only the DER, and supplying power from both simultaneously. The MSE supports these operating conditions and orchestrates transitions from one mode to another automatically or by command. In examples disclosed herein, MSEs support five operating modes of a microgrid that include parallel, island, utility outage mode, normal mode, and shutdown mode.

Additionally, the MSE disclosed herein is advantageously assembled within a single enclosure that can be transported to job sites via conventional means and in a single piece. Thus, there is no need to join multiple pieces at the job site to form an operating MSE. Accordingly, there are no moisture concerns with seals used to adjoin multiple components. The MSE also provides protection against weather (wind, moisture, lightning, etc.), vandalism, etc. by being assembled within a single enclosure. The enclosure can be a National Electrical Manufacturers Association (NEMA) enclosure that is rated for the outdoors. The enclosure provides protection for components located therein, such as from varmints, physical damage, etc. By arriving as a single assembly, the MSE can be installed by placing it on a pad, attaching line and load cables, attaching communication lines, and connecting protection and controls to the Distributed Electrical Resources for the microgrid.

Furthermore, when interconnecting a pre-certified microgrid resource with the utility provider, the application process is often simplified, and the costs reduced. Utility providers may also waive some of the interconnection requirements which further reduce engineering and equipment costs and shorten the schedule for the project by, for example, expediting the approval process.

Turning now to the figures, FIG. 1 illustrates a block diagram of an example of an MSE 100 constructed according to the principles of the disclosure. The MSE 100 is a single enclosure, universal solution for connecting microgrids to macrogrids. The MSE 100 can be rated for both low and medium voltage classes. For example, the MSE 100 can be rated in the medium voltage class at voltages of 15 kV, 25 kV, and 38 kV. Additionally, the MSE 100 can be rated for a low voltage, such as at 480 volts.

The MSE 100 includes protective relays 110 that are configured to provide relay protection for operating microgrids in multiple modes. The relay protection complies with industry standard requirements, such as IEEE 1547, to protect the resiliency of the macrogrid and utility interconnection standards which were established to protect utility personnel and equipment by providing all major protective relaying requirements in a single package. The protective relays 110 can include a first protective relay and a second protective relay that are configured to provide the redundant relay protection. The first and second relays can be considered primary and back-up relays. In one example, the first and second relays are SEL-751 feeder protection relays from Schweitzer Engineering Laboratories of Pullman, Wash. The protective relays 110 can also include a lock-out relay. One skilled in the art will understand that other relays having similar functionality or other relay protection configurations can be used to provide the relay protection disclosed herein.

The protection features provided by the protective relays 110 are capable of detecting utility faults and outages and quickly disconnecting the microgrid from the utility to prevent the DER from supplying fault current to the utility and to permit the facility to continue operating during a utility outage. In addition, the relay protection provided by the protective relays 110 continuously monitors the power consumed or exported by the microgrid to control the DER for load shedding schemes and to prevent export power from exceeding the utility provider's maximum as defined in an interconnection agreement, such as between the utility and the microgrid owner.

The relay protection provided by the protective relays 110 also monitors the utility connection to detect un-expected islanding events which may occur at the utility level resulting from normal utility operations, or as a malicious attack such as exploitation of the so-called Aurora Vulnerability. These events may create a hazardous condition for equipment and personnel when the island is re-connected out of phase. To mitigate this hazard, if the relay protection provided by the protective relays 110 detects this event while the DER is operating, the microgrid is immediately disconnected from the utility and switched to island operation until normal utility conditions are restored.

The protective relays 110 provide protective features required by the National Electric Code for a service entrance. Additionally, since the MSE 100 is employable with microgrids that have the ability of both importing and exporting power, the protective relays 110 also have multiple bi-directional feed features that indicate if power is being imported or exported. The directional protection features can apply differing protection functions and setpoints for importing power and for exporting power. Furthermore, the directional protection features adjust the protection for importing or exporting power in response to changes in the operating modes that corresponds to FIG. 2. For example, if transitioning to export mode, then the directional protection elements can permit power to flow to the utility without tripping relays compared to when the directional protection elements are configured for import mode. The protective relays 110 also include functionality that can be used to allow waving of a transfer trip requirement by the utility. For example, the protective relays 110 can include Negative Sequence Time Overcurrent and Directional Neutral Overcurrent relay functions as identified by American National Standards Institute (ANSI) standard device numbers 51Q and 67N, respectively.

In addition to the protective relays 110, the MSE 100 also includes a power meter 130, a communications module 140, a control and metering interface 150, a line interconnect 160, a load interconnect 170, and a power bus 180. The power bus 180 includes a primary disconnect 184 and an auxiliary disconnect 186. The protective relays 110 can operate both of the disconnects, the primary disconnect 184 and the auxiliary disconnect 186.

The power meter 130 is a revenue grade power quality meter configured to determine the amount of power that is exported and the amount of power that is imported through the MSE 100. The power meter 130 can also monitor for power quality including vector plotting, harmonic analysis, and waveform capture. However, other features may also be possible. Though the utility connected to the MSE 100 will have their own independent metering, the power meter 130 provides verification that the utility metering is correct. The power meter 130, therefore, can be a backup to the utility power metering to confirm that customers are being charged for the correct amount of power being imported or exported. In one example, the power meter 130 can be a SEL-735 power quality and revenue meter available from Schweitzer Engineering Laboratories.

The communications module 140 is communicatively coupled to and is configured to actively communicate with the protective relays 110. The communication module 140 is further configured to communicate with the protection and controls of a utility connected to the MSE 100. In one example, the communication module 140 includes a cellular modem for communicating with the protection and controls of the utility and other components external to the MSE 100. The communications module 140 can include a non-cellular connection, such as a wired, wireless LAN, or fiber optic connection to the utility. For example, the communications module 140 can be configured to communicate via a transfer trip line, a cellular modem, or a combination of both.

The communications module 140 can also be configured to communicate with the utility and the facility hosting the load and/or DER. The communications module 140 can communicate with a Supervisory Control and Data Acquisition (SCADA) system of the customer's facility (e.g., owner of the microgrid) or the SCADA for the utility. In some implementations, the communications module 140 can interface with a building automation system for a commercial facility or regular SCADA for an industrial facility. The communications module 140 can receive various commands, such as from the utility or the facility hosting the load and/or DER, via these coupled systems and communicate necessary instructions to the protective relays 110 to enable the commands. Accordingly, a single command, instead of multiple commands or instructions, can be sent to the MSE 100 and the communications module 140 can then send the needed instructions to, for example the protective relays 110, to enable the command. For example, an “island mode” command can be received by the communications module 140 that then communicates instructions to enable island mode. The instructions can be sent to both primary and back-up relays of the protective relays 110. The protective relays 110 can send control signals, such as to the primary disconnect 184, for enabling the command.

In one example, the communications module 140 can include or be coupled with a programmable logic controller that is configured or programmed to automatically distribute commands or instructions to enable an operating or transition mode of the MSE 100 in response to receiving a command for that particular mode. The communications module 140 can also pull real time data from the protective relays 110, such as from both primary and back-up relays, and present the collected data for review. The collected data can also be used for real time automation control of the MSE 100. In some examples, the communications module 140 can include a data concentrator that collects data and allows access control. A control port and a read only port can be used to provide isolation and control of the data. A data station, such as available from Red Lion Controls of York, Pennsylvania, can be used for collecting and managing the data.

The control and metering interface 150 provides an interface for external connections. The control and metering interface 150 provides universal voltage transformer (VT) and current transformer (CT) connectivity for electrical protection and control equipment that is independent of the DER or customer facilities connected to the MSE 100. The voltage and current outputs provided to the control and metering interface 150 can be used by the customer to connect an energy controller to control their particular type of energy source, such as wind, solar, generator, battery storage system, etc. In one example, the control and metering interface 150 includes voltage and current sensing signals, dry-contact statuses and hard-wired commands that can be driven by dry-contacts in the customer's facility. The control and metering interface 150 can employ conventional connectors such as screw terminal blocks.

The line interconnect 160 and the load interconnect 170 are configured to provide connections to the utility grid and the load, respectively. The line interconnect 160 and the load interconnect 170 can employ conventional connectors used for underground connections in the industry and that are rated at the appropriate voltage and current for the power bus 180.

The power bus 180 is configured to deliver power between the line interconnect 160 and the load interconnect 170. The power bus 180 is a bus bar that is rated for the amperage of the equipment connected to the MSE 100. The power bus 180 is coupled to both the protective relays 110 as well as the power meter 130 to obtain current and voltage measurements. For example, the power bus 180 can be coupled to the protective relays 110 via current transformers. The power bus 180 includes the primary disconnect 184 that is connected in series to the auxiliary disconnect 186.

Each of the above components of the MSE 100 is included within an enclosure 190. The enclosure 190 is constructed of metal typically used for pad-mounted switchgear in the electrical industry. The enclosure 190 includes a bottom side (not shown) having openings for the underground connections to the line interconnect 160 and the load interconnect 170. The enclosure 190 provides protection for the multiple components against tampering, weather, animals, nature, and vandalism, during shipping, installation, and after installation. The enclosure 190 also provides a controlled environment that can improve the reliability of the MSE 100 when in service. For example, connections between the different components of the MSE 100 are located within and protected from external influences by the enclosure 190. In some installations, the dimensions of the enclosure 190 may be 60″ wide, 84″ deep, and 48″ tall. Advantageously, each of the components of the MSE 100 are included in the defined space of the enclosure 190 and still maintain the proper clearances required for the rated voltage and equipment of the MSE 100. Additionally, the MSE 100 includes a low-voltage compartment 192 and a high-voltage compartment 194 that are separated by a barrier 196. The low-voltage equipment and connections are housed within the low-voltage compartment 192 and the high-voltage equipment and connections are housed within the high-voltage compartment 194. Having the separate low and high voltage compartments 192, 194, provides protection for service personnel to perform at least some maintenance procedures while the MSE 100 is in operation. The protective relays 110, the power meter 130, and test switches, for example, can be mounted on a control panel located in the low-voltage compartment 192.

FIG. 2 illustrates a state diagram 200 of the operating modes and transitions between the operating modes of an example MSE constructed according to the principles of the disclosure. As noted above, multi-mode microgrids can actively generate power and operate either in parallel, connected to the utility, or as an island, disconnected from the utility. The state diagram 200 presents the various operating modes and transition functions supported by the MSEs disclosed herein, such as MSE 100. The five operating modes include parallel 210, island 220, utility outage mode 230, normal mode 240, and shutdown mode 250. The state diagram 200 also includes two operating regions, utility 260 and DER 270, that represent the active source or sources of power for a load connected to the MSE for the various operating modes. When in parallel mode 210 and normal mode 240, power is provided to the load by the utility. When in parallel mode 210, island mode 220, and utility outage mode 230, power is provided to the load by the DER. When operating entirely from the DER, the MSE is in an open position and no power travels through the power bus of the MSE. However, the MSE continues to monitor voltage from the utility and the DER to determine the status of the utility supply and to supervise synchronization operations in various operating modes and transitions. A communications module, such as communications module 140, can be used to centralize data gathered during the monitoring and can provide instructions for enabling the various modes.

A microgrid resource operating in parallel mode 210 will typically do so to perform partial or total load shedding, or to export power to the utility. Under this condition, the utility provider supplies the net real power (kW) and the net reactive power (kVAR) being consumed by the load less the amount being produced by the DER. If the power produced by the DER exceeds the power consumed by the load, the excess power is supplied to other loads connected to the utility and can be tracked by the utility's power meter using either net metering or separately with a two-channel/bi-directional meter. A microgrid owner may also choose to operate their microgrid in the parallel mode 210 for economic reasons, including participation in load reduction or emergency generation programs, to mitigate utility demand charges, to reduce utility consumption fees, or to sell exported power.

During island mode 220, the microgrid is completely disconnected from the utility service provider and all facility loads are supplied by the DER. This is most often required when utility power has failed and the microgrid is used to supplement or replace traditional emergency generation equipment. The island mode 220 can also be proactively initiated by an operator prior to planned utility outages or when an unplanned outage is likely to occur. For example, an operator may island their facility, i.e., operate in island mode, to protect their equipment from possible surges and sags on the utility line during heavy electrical storms. Additionally, the operator can select island mode 220 to prevent the short period of power loss that occurs while the DER is being started immediately following a utility outage that was unplanned but could be predicted (e.g. during high-winds or when heavy ice forms on trees near power lines). This allows the operator to avoid large expenses related to loss of product and start-up time that may result from even a few seconds of utility outage.

State diagram 200 shows two modes used for DER only operation, island mode 220 and utility outage mode 230. Island mode 220 is only initiated by command, and likewise only exits that mode when commanded to do so. However, the Utility Outage mode 230 is automatically entered and exited when the MSE detects a utility outage and the following restoration. The difference between these operating modes is whether the MSE is permitted to automatically exit the mode. Island operation is used herein to collectively refer to both the Island mode 220 and the Utility Outage mode 230 when the distinction is not needed.

The MSE's primary responsibility in island operation is management of the power bus disconnects, such as circuit breakers, when entering and leaving these modes. When entering the Utility Outage mode 230, the MSE opens the primary disconnect when a utility outage has been detected before then calling for the DER to start and supply the load. However, when entering Island mode 220, the already running DER is first commanded to match the supplied power with the power consumed by the load before opening the circuit breaker. The DER is also commanded by the MSE to modify its control system for island operation, and thereby permit and require the MSE to manage the voltage and frequency of the now islanded microgrid.

When exiting either the island mode 220 or the utility outage mode 230, the MSE first initiates a synchronization operation by the DER to match the voltage, frequency, and phase angle of the microgrid to the utility. When the DER indicates that a match has been achieved and requests closing of the primary disconnect, the MSE uses a synchronism-check to verify that it can close the primary disconnect safely before allowing the operation. At this point the DER is returned to Parallel mode 210, when exiting Island mode 220, or it is requested to stop, when exiting the Utility Outage mode 230 and returning to the Normal mode 240.

The MSE also provides a Shutdown mode 250 which will open the primary disconnect but will not call for the DER to supply the load. This mode is typically only required when the microgrid must be completely de-energized to perform scheduled maintenance and only after the load completes its own shutdown procedures. In certain embodiments, such as medium voltage MSEs, the MSE includes an air-switch as a power bus disconnect, such as the auxiliary disconnect 186. In such embodiments, safety procedures also require that the MSE's air-switch be opened and locked out, and that the DERs controls are also locked-out to prevent accidental energization while work is being performed. Some MSEs, such as a low voltage MSE, utilize a molded case circuit breaker instead of an air-switch. The molded case circuit breaker can use a draw-out construction and be without a shunt close coil. This allows the auxiliary disconnect to act as a backup tripping device while preventing automatic re-energization, providing a visible break, and providing locking provisions; in other words, the same functionality provided by the air-switch in other MSE embodiments. A low voltage MSE may not include an auxiliary disconnect in some embodiments. In these embodiments, the primary disconnect will be a circuit breaker of draw-out construction to comply with safety requirements.

Three different transitions between the operating modes are indicated in FIG. 2 by the legend. The transitions are either performed manually by operator command, a manual transition 280, or are performed automatically in response to a condition, an automatic transition 290. Examples of automatic transitions include automatic transitioning with the loss or restoration of utility power 294 and automatically transitioning with the manual opening of disconnect switch 296.

FIGS. 3-5 illustrate various examples of microgrid systems having an MSE as disclosed herein. Each of the microgrid systems have a different power rating and are arranged in a different configuration. The microgrid systems of FIGS. 3-5 are provided as examples to illustrate how an MSE can be employed; other configurations can also be used that employ the MSEs disclosed herein. Each MSE of FIGS. 3 to 5 shows a bus with a primary and a secondary disconnect but do not show the protective relays and connections thereto.

A medium voltage (MV) MSE is employed in FIG. 3 and FIG. 4 and a low voltage (LV) MSE is employed in FIG. 5. In FIGS. 3-5, ANSI standard device numbers are used to represent AC circuit breakers (52) and differential protective relays (87). Additionally, “G” is used to represent a generator or another type of DER. Similarly, the generator switchgears of FIGS. 3 to 5 can have other arrangements and identifiers for other types of DER. The substation, MSE, and switchgears of the FIGS. 3-5 can be connected via conductors or busses typically used in the electrical industry.

FIG. 3 illustrates a one-line diagram of an example microgrid system 300 employing an MSE constructed according to the principles of the disclosure. The microgrid system 300 is for a 10 MW microgrid and includes substation differential protection. The microgrid system 300 includes a customer owned substation 310, an MSE 320, a microgrid switchgear 330, and a generator switchgear 340.

The customer owned substation 310 includes a 138 KV to 12.5 KV transformer 312 that receives a 138 KV primary transmission service via an AC circuit breaker 314 and transforms the 138 KV to 12.5 KV for delivery to the MSE 320. The AC circuit breaker 314 is controlled by a differential protective relay 316 that is coupled to a current transformer 318 located on the 138 KV side of the AC circuit breaker 314.

The MSE 320 includes an AC circuit breaker 322 that receives the 12.5 KV service from the customer owned substation 310. The MSE 320 also includes a disconnect 324 and current transformer 326 that is connected back to the differential protective relay 316 of the customer owned substation 310. The current transformer 326 is on the load side of the MSE 320. A bus bar 332 of the microgrid switchgear 330 is also coupled to the load side of the MSE 320.

The bus bar 332 is coupled to three different feeders that are connected to a first load, a second load, and the generator switchgear 340. Each of the different feeders has an AC circuit breaker, which are collectively referred to as circuit breakers 334. The generator switchgear 340 includes a bus bar 342 and three feeders that are connected to generators. Each of the three feeders includes an AC circuit breaker, collectively denoted as circuit breakers 344.

FIG. 4 illustrates a one-line diagram of an example microgrid system 400 employing an MSE 410 constructed according to the principles of the disclosure. The microgrid system 400 is for a 5 MW microgrid and includes switchgear differential protection. The microgrid system 400 includes the MSE 410, a microgrid switchgear 420, and a generator switchgear 430.

The MSE 410 includes an AC circuit breaker 412 that receives a 12.5 KV distribution service from a utility and that is controllably connected to a differential protective relay 422 of the microgrid switchgear 420. The MSE 410 also includes a current transformer 414 on the line side of the MSE 410 that is connected to the differential protective relay 422, and a disconnect 416 on the load side of the MSE 410. A bus bar 424 of the microgrid switchgear 420 is also coupled to the load side of the MSE 410.

The bus bar 424 is coupled to three different feeders that are connected to a first load, a second load, and a bus bar 432 of the generator switchgear 430. Each of the different feeders have an AC circuit breaker, that are collectively referred to as circuit breakers 426, and are each coupled to the differential protective relay 422. The bus bar 432 is connected to three feeders that are connected to generators. Each of the three feeders has an AC circuit breaker, collectively denoted as circuit breakers 434.

FIG. 5 illustrates a one-line diagram of an example microgrid system 500 employing an MSE 510 constructed according to the principles of the disclosure. The microgrid system 500 is for a 1 MW microgrid that enables generator provided load following. The microgrid system 500 includes an MSE 510 and a load panel 520. Each of the circuit breakers illustrated in FIG. 5 is a non-draw-out circuit breaker.

The MSE 510 includes a pair of AC circuit breakers 512, 514, and a load side current transformer 516. The MSE 510 receives a 480 V secondary service that is provided to a bus bar 522 of the load panel 520 via the AC circuit breakers 512, 514. The load side current transformer 516 is coupled to a generator 530 that is also coupled to the bus bar 522 via an AC circuit breaker 524. Various loads are also coupled to the bus bar 522 via AC circuit breakers collectively denoted as circuit breaker 526. The current transformer 516 is an optional component that is not included in some embodiments.

As discussed above, the MSE can provide a single solution for multiple microgrid installations. The MSE can also enable tasks that are not possible, or are more complex, when using other microgrid architectures. FIGS. 6 and 7 illustrate flow diagrams showing examples of such tasks enabled by an MSE as disclosed herein. At least some of the steps of the methods of FIGS. 6 and 7 can be carried out by an MSE, such as MSE 100 or the MSEs of the microgrid systems in FIGS. 3 to 5.

FIG. 6 illustrates a flow diagram of an example of a method 600 of placing a microgrid in an island mode to allow utility work to be safely conducted. The method 600 begins in a step 610 with the receipt of a work order. The work order can be an un-planned emergency work order or a scheduled work order. The work order can be originated by a utility for work on their system.

In a step 620, a command to enter island mode is received by an MSE. The command can be generated or sent by an operator for the utility. The command can be received by a communications module of the MSE.

In response to receipt of the island mode command, the MSE starts the DER and opens the primary disconnect in a step 630. The communications module can send the necessary commands or instructions to the DER and the primary disconnect of the MSE to implement the island mode. Accordingly, from a single island mode command, the MSE can send the necessary commands to the proper equipment to enable the island mode.

The MSE then indicates in a step 640 that the island mode is established. The indication can be sent to entities, such as the utility, via the communications module of the MSE. A visual indication at the MSE can also be provided.

In a step 650, a command to open an auxiliary disconnect is received by the MSE. The command can be received from an operator of the utility. The auxiliary disconnect is a disconnect that cannot be or can be prevented from being automatically closed. For example, the auxiliary disconnect can be an air-switch that can be opened and locked out or a draw-out circuit breaker. Auxiliary disconnect 186 is an example.

The opened auxiliary disconnect is then locked out and tagged out in a step 660. Step 660 is typically performed by the utility according to their lock out and tag out procedures. Lock-out equipment can be used that physically restrains operation of the auxiliary disconnect or prevent insertion of an operating mechanism (e.g. an operating crank or lever). Steps 650 and 660 prevent automatic re-energization and provide a visible break. In some applications, such as for low voltage, the MSE may not include an auxiliary disconnect. To prevent automatic re-energization and a visible break, the primary disconnect can be a circuit breaker of draw-out construction that complies with safety requirements. The method 600 ends in step 670 where utility work can be safely conducted.

FIG. 7 illustrates a flow diagram of an example of a method 700 of placing a microgrid in a normal mode. The method 700 begins in a step 710 with completion of utility work. The utility work can be the work performed in step 670 of the method 600. The same MSE as used with method 600 can be used with method 700.

In a step 720, a lock-out of an auxiliary disconnect is removed. The utility can perform the removal of the lock-out and the lock-out removal can include removing lock-out equipment from the operating lever of an air switch.

In a step 730, the auxiliary disconnect is manually closed. The utility typically performs step 730 and this step can include closing the air switch using the operating lever or placing a draw-out circuit breaker back into service position.

A command to enter normal mode is received by the MSE in a step 740. The command can be generated or sent by an operator for the utility. The command can be received by the communications module of the MSE.

In response to receipt of the normal mode command, the MSE synchronizes the DER with the utility and closes the primary disconnect in a step 750. The communications module can communicate with the protective relays of the MSE and employ a synchronism-check feature thereof for the synchronizing. The MSE then unloads and shuts down the DER in a step 760. The communications module can send the necessary commands or instructions to the DER and the primary disconnect of the MSE to implement the normal mode. Accordingly, from a single normal mode command, the MSE can synchronize the DER and utility, close the primary disconnect, unload the DER, and shut down the DER. The method 700 ends in step 770 where utility power has been restored.

A portion of the above-described apparatus, systems or methods, such as sending instructions, control signals, or commands to enable operating modes in response to received commands, can be embodied in or performed by various digital data processors, computing devices, or controllers, that are programmed or store executable programs of sequences of software instructions to perform one or more of the steps of the methods or functions of the apparatus or systems. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A microgrid service entrance (MSE), comprising:
an enclosure;
protective relays having bi-directional protection;
a communications module communicatively coupled to the protective relays; and
a power bus coupled to the protective relays and including a primary disconnect, wherein the protective relays, the communications module, and the power bus are located within the enclosure.

2. The MSE as recited in claim 1, wherein the power bus further includes an auxiliary disconnect connected in series with the primary disconnect.

3. The MSE as recited in claim 2 wherein at least one of the primary and auxiliary disconnects is a circuit breaker.

4. The MSE as recited in claim 3 wherein the circuit breaker is a draw-out circuit breaker.

5. The MSE as recited in claim 2 wherein the auxiliary disconnect is an air-switch.

6. The MSE as recited in claim 1, wherein the protective relays provide redundant relay protection.

7. The MSE as recited in claim 1 wherein the protective relays are programmed to provide at least three operating modes and at least two transition modes.

8. The MSE as recited in claim 7 wherein the at least three operating modes are an island mode, a normal mode, and a utility outage mode.

9. The MSE as recited in claim 7 wherein the two transition modes are a parallel mode and a shutdown mode.

10. The MSE as recited in claim 1 wherein the protective relays are programmed to provide a synching check function.

11. The MSE as recited in claim 1 further comprising a power meter located within the enclosure, electrically coupled to the power bus, and communicatively coupled to the communications module.

12. The MSE as recited in claim 1 further comprising a control and metering interface located within the enclosure.

13. The MSE as recited in claim 1 wherein the communications module is configured for one or more methods of communication.

14. The MSE as recited in claim 1 further comprising a line interface and a load interface, wherein the line interface is connected to the load interface via the power bus.

15. The MSE as recited in claim 1 wherein the power bus is rated for 480 volts, 15 kV, 25 kV, or 38 kV.

16. A method of changing operating modes for a microgrid, comprising:
receiving, at a microgrid service entrance (MSE) for a microgrid in a first operating mode, a command to place the microgrid in a second operating mode;
sending instructions, based on the command, to operate components of the MSE to place the microgrid in the second operating mode; and
indicating, by the MSE, that the microgrid is operating in the second operating mode.

17. The method as recited in claim 16 wherein the first operating mode is a normal mode and the second operating mode is an island mode.

18. The method as recited in claim 16 wherein the components include a primary disconnect and protective relays.

19. A microgrid service entrance (MSE), comprising:
an enclosure;
protective relays configured to operate the MSE in at least three operating modes and provide redundant relay protection;
a communications module communicatively coupled to the protective relays and configured to send at least one instruction to the protective relays to enable operating the MSE in one of the at least three different operating modes based on a received command; and
a power bus coupled to the protective relays and including a primary disconnect coupled in series to an auxiliary disconnect, wherein the protective relays operate the primary disconnect in response to the at least one instruction, and the protective relays, the communications module, and the power bus are located within the enclosure.

20. The MSE as recited in claim 19 wherein the protective relays are further programmed to provide a synching check function, the at least three operating modes are an island mode, a normal mode, and a utility outage mode, and the primary disconnect is an AC circuit breaker.
